(19) United States
(12) Patent Application Publication
(10) Pub. No.: US 2004/0267650 A1
(43) Pub. Date: Dec. 30, 2004

(54) Method and system for collecting monetary donations

(76) Inventor: Andrew Bryan Burnett, Brooklyn, NY (US)

Correspondence Address: Darcell Walker, Suite 250, 9301 Southwest Freeway, Houston, TX, 77074, US

(21) Appl. No.: 10/880,671

(22) Filed: Jun. 30, 2004

Related U.S. Application Data
(60) Provisional application No. 60/483,880, filed on Jun. 30, 2003.

(51) Int. Cl. G06F 17/60

(52) U.S. Cl. 705/35; 705/40

(57) ABSTRACT

The present invention provides a method and system that electronically collects monies from donor individuals and organizations and distributes these collected monies to designated charitable and other non-profit organizations such as churches. The donor will supply information related to the identity of the designated recipient organization, the amount or percentage of the donation and the frequency of the donations. At designated donation intervals, the specified or calculated monetary amount is transferred from the donor account to the collecting agency. The funds are then transferred to the recipient organization account by the collecting agency. At the completion of this transfer, both the donor and the recipient organization can receive verification of the amount of the transfer. During the time interval between transfers from the donor account, the donor can modify the information that controls the amount of a monetary transfer and the frequency of the transfers from the donor account.

### CROSS-REFERENCE TO RELATED APPLICATION

This application claims priority for a previously filed provisional patent application number 60/483,880 filed on Jun. 30, 2003 the contents of which are herein incorporated by reference.

### FIELD OF THE INVENTION

The present invention relates to a method and system that enables persons and organizations to electronically donate monetary funds to charities and other non-profit organizations in a more efficient manner and more particularly to a method and system for electronically collecting donated funds and distributing these donated funds to the designated charity or non-profit organization.

### BACKGROUND OF THE INVENTION

Charities and other non-profit organizations provide many services to the community. As a result, many communities have ground to rely on these types organizations during tough times and times of emergency and crisis. A few of these organizations have endowments or receive large contributions from wealthy citizens. However, most of these types of organizations receive the bulk of their operating revenues for implementing many of the programs from individual and corporate donations.

These non-profit organizations have various activities in order to raise funds for various services that they provide to the community. Some major organizations have telethons and fund raising campaigns to generate contributions. Other organizations work with companies to get the employees to donate to these organizations through these companies. In this process, employees designate a certain amount of money to be sent to an organization through a payroll deduction process. In this process, the designate money is taken directly from the employee's paycheck and sent to the designated organization. With this approach, the individual does not have the responsibility of actually paying the money to the organization.

In many instances, the payroll deduction method of payment is more efficient and more productive in terms of generating funds for an organization, than some other fund raising methods. In the traditional pledge method, people pledge a certain amount of money, but are responsible for paying the pledge. Many times, the individual making the pledge does not pay some or any of the pledge. One factor that contributes to this failure to pay the pledge is a lack of discipline and commitment by many persons making these pledges. Automatic payment systems, such as payroll deduction, reduce the discipline necessary by an individual in order to full a pledge to donate money to an organization.

Another arena where there is a lack of commitment to pay monies is in giving to religious institutions, in particular churches. Most churches receive their monetary resources from members of the church and other persons that attend services at the particular church. The ability of a church to minister to the needs of the community is dictated in large part by the amount of monetary resources collected by the church. For persons practicing Christianity in particular, there is a belief that ten percent of the persons income should be give to the church in the form of a tithe. Even though the principle of tithing is established in Christianity, research reveals that of the people who attend church services on a regular basis, only three to five percent of the people who donate money to the church give ten percent or more of their income to the church. Studies have concluded that one out of every six adults (17%) claims to tithe (give 10 percent of their income to the church). However, a comparison of the amount that people gave to churches and their household income reveal that just six percent of the people actually donated one-tenth of their income to churches. Also, two out of every five born again adults who admitted to not currently tithing stated that they hoped to do so in the future.

With respect to giving to churches, there appears to be two major trends. First, the Baby Bust generation, which includes adults born from the mid-1960's to the early-1980's, barely, gives to churches or religious causes. Second, the Baby Boomers, adults born from the mid-1940's to the early-1960's, are generous donors, but simply do not assume that they should give to churches. These Baby Boomers are value donors, giving to organizations that they perceive to be providing personal benefits or significant, unduplicated value to society. As these two generations become more prolific within churches, their tendency to give less to churches will challenge ministries to re-conceptualize their budgeting, fundraising and planning practices.

With any of the current fundraising methods or practices, there are no legal obligations on the donors to give a certain amount of money or to honor any pledged amount of money. As a result, the amounts of money collected by these organizations and the consistency of the donations is a result of the commitment and discipline of the donors. With the payroll deduction practices as apparently the only proven method for consistently collecting monetary funds, there remains a need for a method and system that can enable donors to meet commitments, pledges and expectations related to giving monetary donations to organizations in addition to an of an employee/employer relationship.

### SUMMARY OF THE INVENTION

It is an objective of the present invention to provide a method and system for donors to automatically and systemically donate monies to designated organizations.

It is a second objective of the present invention to provide a method and system that will enable organizations to more efficiently collect donations.

It is a third objective of the present invention to provide a method and system that electronically collects donations and electronically distributes these donations to designated organizations.

It is a fourth objective of the present invention to provide a method and system for collecting and distributing donations that has inherit accountability components to both the donor and recipient.

It is a fifth objective of the present invention to provide a method and system that provides reports of donations to both the donor and the recipient organization.

The present invention provides a method and system that electronically collects monies from donor individuals and organizations and distributes these collected monies to designated charitable and other non-profit organizations such as churches. The present invention simplifies the process for many individuals to donate monies to organizations. In the method of the present invention, a donor can enroll in a program that will enable the donor to donate money to an organization that is participating in this same program. During the enrollment process, the donor will supply information related to the identity of the designated recipient organization, the amount or percentage of the donation and the frequency of the donations. In addition, since these donations will be in the form of electronic transfers, the donor will also supply account information during this enrollment process. The donor information is verified and transmitted to the collecting agency administering the program and can also be sent to the recipient organization. At designated donation intervals, the specified or calculated monetary amount is transferred from the donor account to the collecting agency. The funds are then transferred to the recipient organization account by the collecting agency. At the completion of this transfer, both the donor and the recipient organization can receive verification of the amount of the transfer. During the time interval between transfers from the donor account, the donor can modify the information that controls the amount of a monetary transfer and the frequency of the transfers from the donor account.

### DESCRIPTION OF THE DRAWINGS

FIG. 1 is a conventional computing device that a donor can use to transmit information to and receive information from the collecting agency and or a recipient organization.

FIG. 2 is a diagram of a computer network over which electronic messages may be transmitted between a sender and receiver in the present invention.

FIG. 3 is a flow diagram of the basic steps in the method of the present invention.

FIG. 4 is a flow diagram of the method of the present invention incorporating donor modification steps.

FIG. 5 is a more detailed flow diagram of the steps in the method of the present invention.

FIG. 6 is a configuration of the system of the present invention.

### DESCRIPTION OF THE INVENTION

The present invention incorporates electronic fund transfer (EFT) technology in its implementation. Today, this ETF technology is commonly used in many financial transactions. For example, persons use this technology to pay bills via a computing network. Companies use this technology to pay vendors or employees. With ETF technology, monies are directly deposited into a recipient's accounts without any direct involvement of the recipient. EFT has proven to be a convenient way to perform financial transactions.

With the various current financial payment models, such as payroll deduction and electronic fund transfer, the transactions typically involve a one-time fund transfer either from the employer to the account of the payee or from individual to a merchant. With credit card transactions, the credit institution that issued the card is a third party in the financial transaction. Still another example of a payment system is one in which tuition for schools is collected by a third party and submitted to the school. With this system, the school is relieved of the periodic task of collecting the tuitions.

With respect to the systems used by individuals to pay bills and other financial obligations, none of these models has the flexibility to adequately accommodate the characteristics of donors to charitable organizations. For example, all of these models have rigid payment schedules. In addition, the payer has little control over or input into determining the payment schedules or monetary amounts of the payments. Typically, the payer is told when to pay and the minimum amount to pay.

The present is a method and system that gives the donor (payer) the control to determine the payment schedule and the amount of any EFT donation to a charity or non-profit institution. The present invention incorporates a collecting agency to receive donated funds from individuals designated for a particular institution. The agency then forwards the collected funds to the designated institution. Although this system has some similarities to the above-described tuition payment system, there are significant differences between that system and the present invention that will be revealed during the description of the invention.

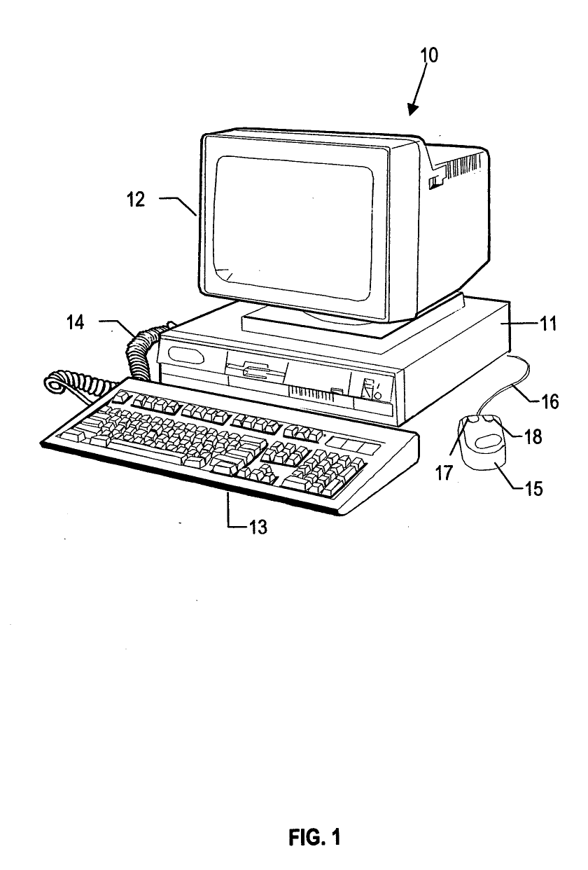

Referring to FIG. 1, there is depicted a pictorial representation of computing device 10 which may be used in implementation of the present invention. The implementation of the method of the present invention will be via electronic transfer over local or global computing networks. A donor will interface with the system via a computing device such as this conventional device. As may be seen, the data processing system 10 includes processor 11 that preferably includes a graphics processor, memory device and central processor (not shown). Coupled to processor 11 is video display 12 which may be implemented utilizing either a color or monochromatic monitor, in a manner well known in the art. Also coupled to processor 11 is keyboard 13. Keyboard 13 preferably comprises a standard computer keyboard, which is coupled to the processor by means of cable 14. Also coupled to processor 11 is a graphical pointing device, such as mouse 15. Mouse 15 is coupled to processor 11, in a manner well known in the art, via cable 16. As is shown, mouse 15 may include left button 17, and right button 18, each of which may be depressed, or “clicked”, to provide command and control signals to data processing system 10. While the disclosed embodiment of the present invention utilizes a mouse, those skilled in the art will appreciate that any graphical pointing device such as a light pen or touch sensitive screen may be utilized to implement the method and apparatus of the present invention. Upon reference to the foregoing, those skilled in the art will appreciate that data processing system 10 may be implemented utilizing a personal computer.

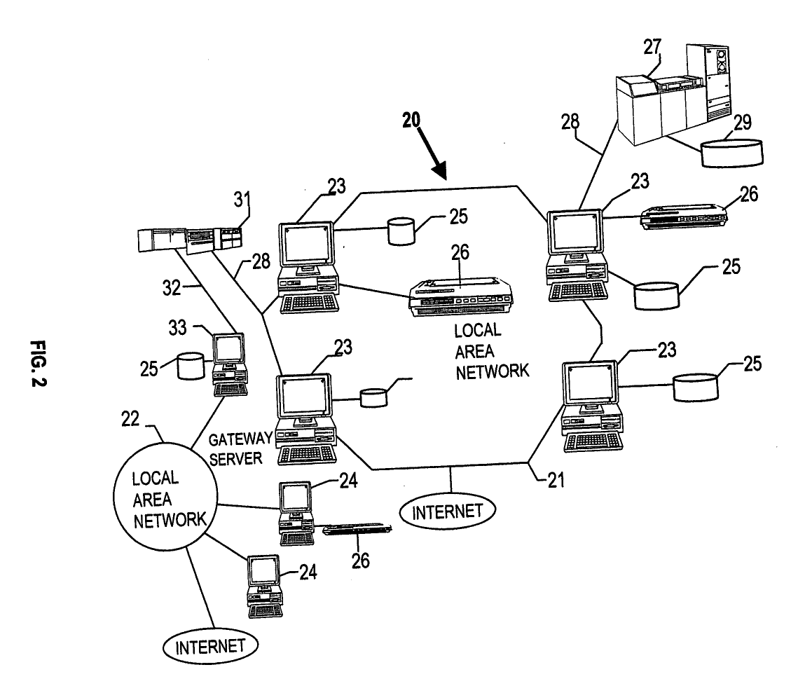

The method of the present invention may be implemented in a global computer network environment such as the Internet. Many monetary transactions occur over local and global computing networks using secure lines to protect the information of the customers and merchants. With reference now FIG. 2, there is depicted a pictorial representation of a distributed computer network environment 20 in which one may implement the method and system of the present invention. As may be seen, distributed data processing system 20 may include a plurality of networks, such as Local Area Networks (LAN) 21 and 22, each of which preferably includes a plurality of individual computers 23 and 24, respectively. Of course, those skilled in the art will appreciate that a plurality of Intelligent Work Stations (IWS) coupled to a host processor may be utilized for each such network. Any of the processing systems may also be connected to the Internet as shown. As is common in such data processing systems, each individual computer may be coupled to a storage device 25 and/or a printer/output device 26. One or more such storage devices 25 may be utilized, in accordance with the method of the present invention, to store the various data objects or documents which may be periodically accessed and processed by a user within distributed data processing system 20, in accordance with the method and system of the present invention. In a manner well known in the prior art, each such data processing procedure or document may be stored within a storage device 25 which is associated with a Resource Manager or Library Service, which is responsible for maintaining and updating all resource objects associated therewith.

Still referring to FIG. 2, it may be seen that distributed data processing system 20 may also include multiple mainframe computers, such as mainframe computer 27, which may be preferably coupled to Local Area Network (LAN) 21 by means of communications link 28. Mainframe computer 27 may also be coupled to a storage device 29 which may serve as remote storage for Local Area Network (LAN) 21. A second Local Area Network (LAN) 22 may be coupled to Local Area Network (LAN) 21 via communications controller 31 and communications link 32 to a gateway server 33. Gateway server 33 is preferably an individual computer or Intelligent Work Station (IWS), which serves to link Local Area Network (LAN) 22 to Local Area Network (LAN) 21. As discussed above with respect to Local Area Network (LAN) 22 and Local Area Network (LAN) 21, a plurality of data processing procedures or documents may be stored within storage device 29 and controlled by mainframe computer 27, as Resource Manager or Library Service for the data processing procedures and documents thus stored. Of course, those skilled in the art will appreciate that mainframe computer 27 may be located a great geographical distance from Local Area Network (LAN) 21 and similarly Local Area Network (LAN) 21 may be located a substantial distance from Local Area Network (LAN) 24. That is, Local Area Network (LAN) 24 may be located in California while Local Area Network (LAN) 21 may be located within Texas and mainframe computer 27 may be located in New York.

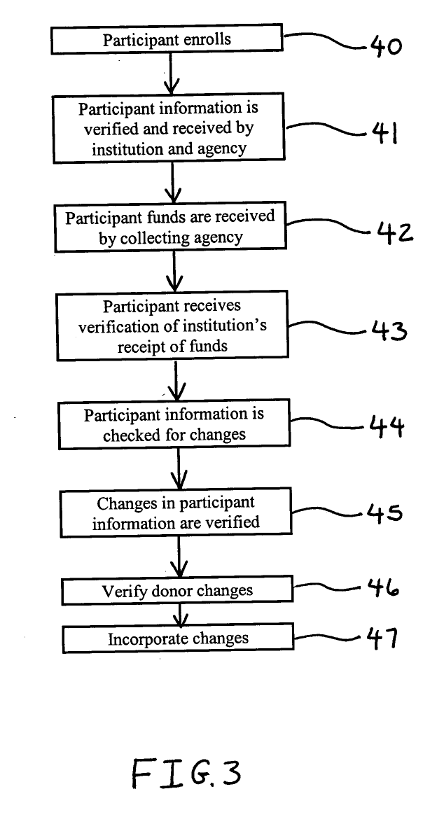

FIG. 3 illustrates the basic steps in the method of the present invention. As shown in step 40, the initial activity once a recipient institution has signed up for the service is to enable donors who want to contribute to the institution via ETF to enroll in the service. This enroll process can be directly with the collecting agency or it can be through the recipient institution. As part of the donor enrollment process, the donor supplies information related to the amount of money that the donor wants to contribute to the institution and the frequency of the contributions. The donor also supplies account information for the account from which the transfer will occur. This account is usually with a bank or credit union account, but it could also be other accounts such as a credit card or line of credit account. The donor can also specify a specific amount to be contributed or the donor can specify a percent from a supplied amount. This percent amount approach is particular applicable when the recipient institution is a church. With this percent contribution approach, components in the system would calculate a contribution amount for the donor based on information supplied by the donor. Because a third party does the collection of funds, system integrity and trust are the most important aspects of this process. The system of the present invention has built-in accountability components to ensure that each transaction is as desired by the donor and recipient institution. As a result, in step 41, the recipient institution verifies the information supplied by the donor. With this verification step, each party to a transaction will know the amount of the donor contribution and the amount received by the institution. At the designated times, the specified funds, from the donor account, are transferred to the collecting agency in step 42. In step 43, participants receive the funds. This step could be implemented via a collection agency that deposits the collected funds for a recipient institution in the institution's account via ETF. In the alternative, collections could be directly between the donor and the recipient institution. At this point, step 44 verifies the receipt of the funds by the recipient institution.

In step 45, the method enters a monitor stage. This stage is during between donations. During this time, the donor may decide to modify the donation information supplied in step 40. For example, the donor may wish to modify the pay interval or amount. When the donor accesses his or her account conveys, probably by clicking an icon, the desire to change account information, step 45 will detect this action. Step 46 will determine if the donor actually changed information in the account. When there are account changes, step 47 incorporates these changes into the donors account information in a manner similar to step 40. After the information is incorporated, the process moves to step 41 where the information is verified. The process can then return to the monitor step 45 until the time reaches the pay interval. At the time of the pay interval, if there is no change in account information step 46 returns the process to step 42 where funds are received at the collecting agency from the donor.

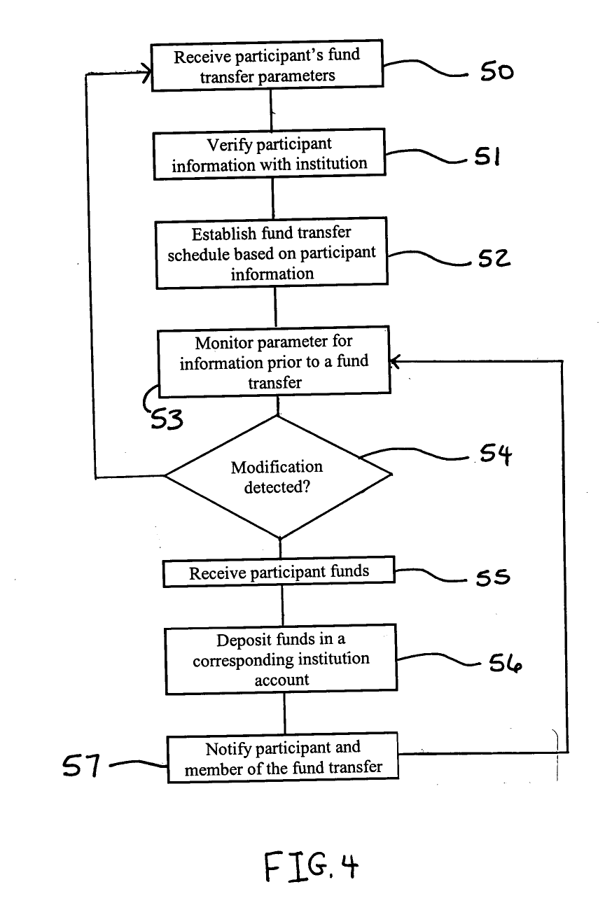

FIG. 4 is an illustration of the interactive steps of system of the present invention. In this implementation, the system receives notification that there is an enrollment request. The system sends a prompt to the donor and in step 50 receives the donor transfer information. In step 51, the donor information is verified with the recipient institution. In step 52, the system creates a payment schedule for the particular donor based on the information received by the donor. As part of this step 52, there can be calculation of the any percent designated by the donor. At this point and prior to any scheduled payment, in step 53, the system monitors for any change in a donor's payment information. To provide maximum flexibility to the donor, the present invention enables the donor to modify the payment schedule as desired by the donor. This ability is not available with any of the other payment models. During this monitoring, if there is a modification, step 54 will detect this modification. When there is a modification, the process for that donor will return to step 51, where the institution will receive notification of the modification. If there is no modification during the monitoring period, step 55 will perform the fund transfer from the donor account to the collecting agency account. Step 56 deposits the collected funds into the account of the recipient institution. The timing of this deposit step can be a function of information supplied to the system by the recipient institution. At the completion of the transaction, the donor and recipient parties are notified of the transfer in step 57.

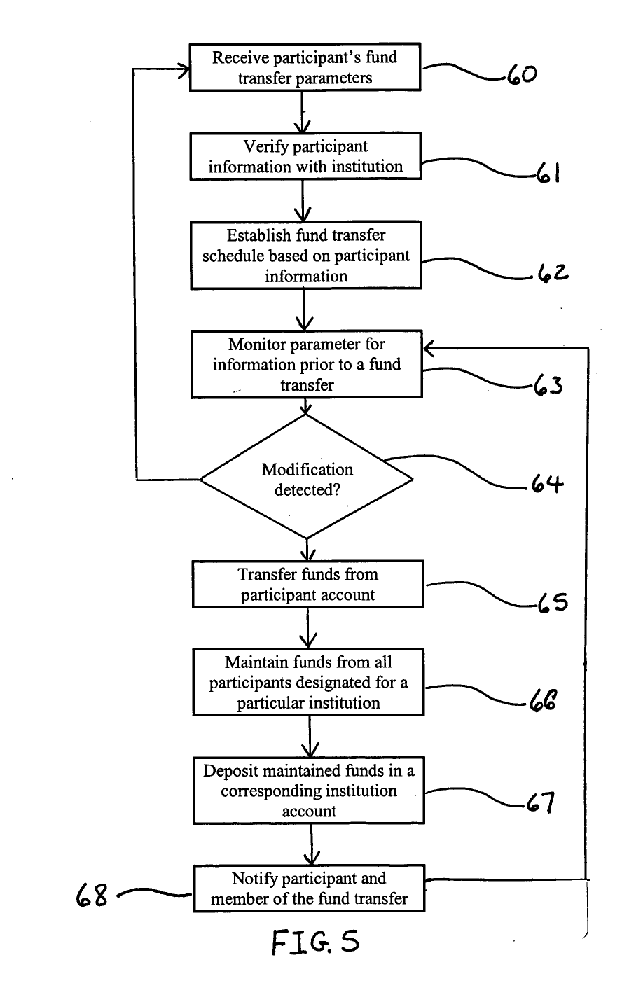

FIG. 5 is an extension of the method in FIG. 4, wherein all of the funds from the donors of a particular institution are maintained for a time period and then makes periodic deposits into the account of the recipient institution. In FIG. 5, steps 60, 61, 62, 63 and 64 are the same as steps 50 through 54 respectively from FIG. 4. In the method of FIG. 5, not every donor to an institution will have the same payment schedule. Therefore, the fund transfer step 65 will occur at different times for the donors. As mentioned, step 66 will maintain all of the funds for the recipient institution until the pay interval to that organization. Step 67 deposits the maintained funds in the account of the recipient institution. Step 68 notifies each participant and the institution of the transfer. For the individual donors, each will receive confirmation of their donation. The verification report to the institution can have a listing of the contribution of each donor. This approach of holding all collected funds for a period of time and then making one deposit during that time period would be more efficient in that there would not be a deposit transaction each time there is a collection transaction. For churches, the preferred time period would be one week.

A payroll deduction/direct deposit model or a similar model could also be implemented in the present invention. Most persons/employees are paid a set amount and at a set time. In addition, many employers pay the employees through direct deposit systems. Referring to the present invention, the transfer schedule could be created to track to the deposit of funds in the employees account.

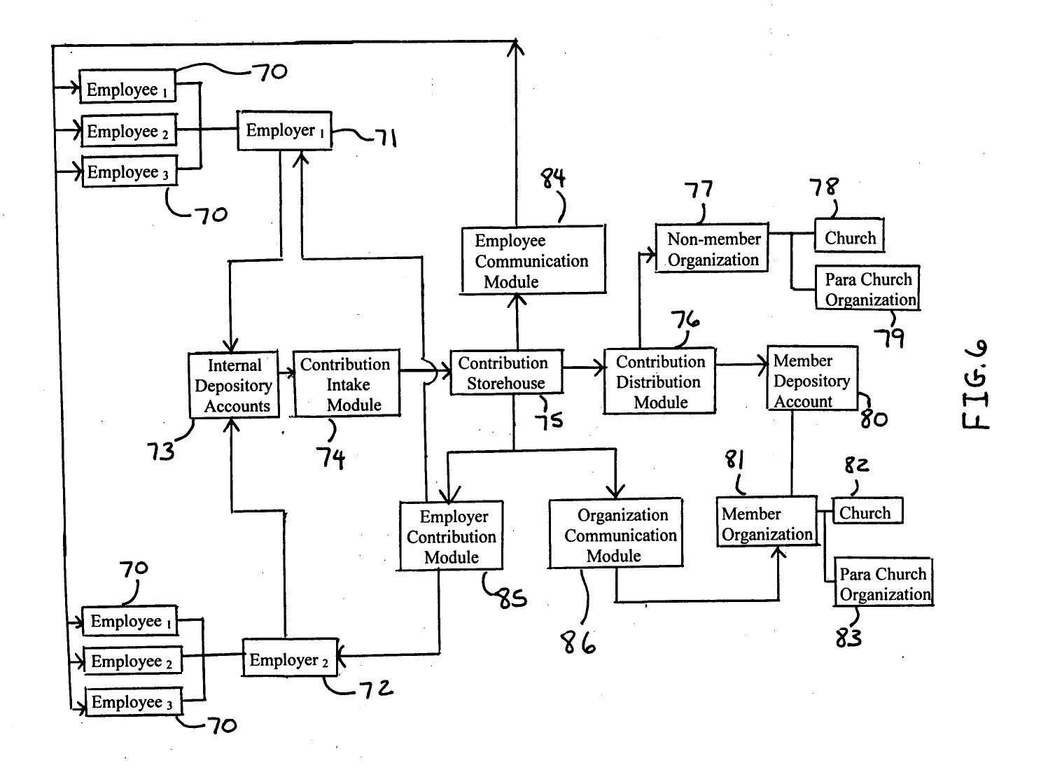

FIG. 6 is a configuration of the system of the present invention that can be implemented in an employee-employer payroll deduct format. As shown, employees 70 participate in the program through employers 71 and 72. Information for the employees is sent via the employer to the collection agency. The collection agency configuration comprises an intake section, a storing section and a distribution section and a reporting section. In the intake section, information is received at the collection agency through the Internal Deposits Account module 73. This module can confirm the amount received from each employer. The collections then move to the contribution intake module 74 where each individual account is identified and credited with the appropriate contribution from that account. At this point, the funds move the storage section where the funds are kept in a holding location 75 until the time for distribution of the funds. At the time of distribution, the funds move from the storage section 75 to the distribution section. A contribution module 76 distributes the funds to the appropriate institution such as non—member organizations 77 which can include churches 78 and other organizations 79. Organizations can become members with the collection agency and receive benefits such as a discount from the collection for this collection service. The distribution can also be to member accounts through the member depository account module 80. From the member deposit account module, the funds go to the appropriate member organizations 81 which can include churches 82 and other non-profit organizations 83.

At the time of the distribution from the storage module 75, reports containing the amount of a donation a sent to the individual donor/employee via an employee communication module 84. The report will contain the amount of the donation and the amount received by the institution. These amounts should be the same. In addition, an employer communication module 85 sent a similar type report to an employer showing the amount of funds received from that employer and the distribution of these funds to the designated institutions. An organization communication module sends similar reports to the recipient organizations showing the amount of the contributions designated for that organization and the amount transferred to that organization. These reports inform each entity of the contributions and help ensure the integrity of the system.

Although this configuration describes the invention in the context of donations through an employer, a similar configuration can be implemented for individuals that do not include an employer. An example can be for a self-employed person that desires to make donations to organizations through system of the present invention.

The present invention adapts ETF technology for new applications related to the collection of funds for charitable and other non-profit organizations. The new applications will increase the amount and consistency of funds donated to these organizations. It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

In addition, it is noted that this invention provides significant advantages over the current art. The invention has been described in connection with its preferred embodiments. However, it is not limited thereto. Changes, variations and modifications to the basic design may be made without departing from the inventive concepts in this invention. In addition, these changes, variations and modifications would be obvious to those skilled in the art having the benefit of the foregoing teachings. All such changes, variations and modifications are intended to be within the scope of this invention, which is limited only by the following claims.

I claim:

1. A method for electronically donating monetary funds to charities and other non-profit organizations comprising the steps of:
receiving payment parameters from a donor;
establishing a payment schedule for that donor;
transferring monetary funds from that donor to a payee institution designated by that donor in the payment parameters; and
notifying the donor and the recipient institution of the monetary transfer.

2. The method as described in claim 1 wherein the payment schedule-establishing step further comprises setting a payment time interval for which monetary funds will be transferred from the donor to the payee institution.

3. The method as described in claim 2 further comprising before said fund transferring step, the step of monitoring the payment information between payment time intervals and detecting any changes in the donor payment parameters.

4. The method as described in claim 1 wherein said transfer funds step further comprises transferring monetary funds from the donor to a collection agency and transferring the funds from the collection agency to the payee institution.

5. The method as described in claim 4 further comprising sending reports to the donor and payee institution prior to a payment transfer identifying the donor, payee institution, the amount of a donor payment and the time of the payment.

6. The method as described in claim 5 further comprising the step of monitoring the payment information between payment time intervals and detecting any changes in the donor payment parameters prior to transferring a payment to the payee institution.

7. The method as described in claim 6 further comprising after said receiving donor payment parameters step, the step of verifying the donor payment parameters.

8. The method as described in claim 7 wherein said receiving donor payment parameters step further comprises receiving donor payment parameters at an employer location.

9. The method as described in claim 6 further comprising verifying detected payee changes and incorporating the changes into the payee parameters.

10. The method as described in claim 4 said transferring step further comprises transferring the funds from the collection agency to distribution location and transferring the funds from the distribution location to the payee institutions.

11. A system for electronically donating monetary funds to charities and other non-profit organizations comprising:
a donor contribution intake module for receiving payments from a donor;
a contribution storage location for storing donor payment prior to distribution to recipient institutions;
a payee reports communication module for sending reports to the donor and the recipient institution; and
a contribution distribution module for distributing the donor payments to the designated recipient institution.

12. The system as described in claim 11 further comprising an internal depository module, said internal depository module for receiving donor payment parameters, initially receiving donor payments and interfacing with the donor.

13. The system as described in claim 11 further comprising an internal depository module, said internal depository module for receiving donor payment parameters, initially receiving donor payments and interfacing with an employer of donor.

14. The system as described in claim 13 wherein said communication module further comprises an employee communication module to send reports to the donor, an employer communication module for sending reports the employer of the donor and an organization communication module for sending reports to the recipient institution.

15. The system as described in claim 13 further comprising a member depository account module for receiving payments from said contribution module.

16. The system as described in claim 13 further comprising a non-member organization module for receiving payments from said contribution module and distributing the received funds to the non-member organizations.

17. A computer program product in a computer readable medium for electronically donating monetary finds to charities and other non-profit organizations comprising:
instructions for receiving payment parameters from a donor;
instructions for establishing a payment schedule for that donor;
instructions for transferring monetary funds from that donor to a payee institution designated by that donor in the payment parameters; and
instructions for notifying the donor and the recipient institution of the monetary transfer.

18. The computer program product as described in claim 17 wherein said transfer funds instructions further comprise instructions for transferring monetary funds from the donor to a collection agency and instructions for transferring the funds from the collection agency to the payee institution.

19. The computer program product as described in claim 18 further comprising after said receiving donor payment parameters instructions, instructions for verifying the donor payment parameters.

20. The computer program product as described in claim 19 wherein said receiving donor payment parameters instructions further comprise receiving donor payment parameters at an employer location.
